(19) United States
(12) Patent Application Publication
(10) Pub. No.: US 2004/0077387 A1
(43) Pub. Date: Apr. 22, 2004

(54) Wireless assembly comprising an ear pad and an intermediate module connected to a mobile telephone

(76) Inventors: Alban Sayag, Thonon-Les-Bains (FR); Roland Sayag, Thonon-Les-Bains (FR); Philippe Rachel, Paris (FR)

Correspondence Address: Oliff & Berridge, PO Box 19928, Alexandria, VA, 22320, US

(21) Appl. No.: 10/472,448

(22) PCT Filed: Mar. 29, 2002
(86) PCT No.: PCT/FR02/01111

(30) Foreign Application Priority Data
Mar. 30, 2001 (FR) 01/04340

(51) Int. Cl. H04R 25/00; H04M 1/00; H04M 9/00

(52) U.S. Cl. 455/575.2; 381/370; 379/430; 455/41.1; 455/41.2

(57) ABSTRACT

The system comprises an ear-piece (2) and an intermediate module (3) connected to the mobile telephone (1). The ear-piece and intermediate module communicate with one another in half-duplex transmission under the control of the ear-piece via a wireless radio link at a frequency of less than 1 GHz, preferably at 434 MHz. The audio signals from the telephone or the ear-piece are converted into digital form before being transmitted by a digital transmission-receipt circuit using phase modulation. The transmitted signals are reconverted into analog form before being applied to a receiver (4) of the ear-piece or to an audio input of the telephone. A control button (19) located, on the ear-piece can enable the ear-piece to be powered on, the telephone to be remotely connected and disconnected, and a microphone (5) of the ear-piece to be actuated when the microphone is telescopic. This system enables hands-free use of the telephone without any health hazards.

### BACKGROUND OF THE INVENTION

The invention relates to a wireless system comprising an ear-piece and an intermediate module connected to a mobile telephone, the ear-piece and intermediate module both comprising a transmission-receipt circuit to communicate digital data to one another at a preset transmission frequency.

### STATE OF THE ART

In known systems (U.S. Pat. No. 6,078,825, GB-A-2,277,422), audio data transmission between the ear-piece and the intermediate module is performed in analog form. The technique used is similar to that which is used by the mobile telephone, with transmission frequencies in the microwave range. However questions are more and more frequently being asked as to the possible impact of the radiation, even low level radiation, emitted by mobile telephones on the health of frequently exposed subjects.

The document WO-A-0,108,386 describes transmission of digital data at frequencies of 27 or 48 MHz between an ear-piece comprising a transponder and an accessory connected to the mobile telephone. In practice, the system described can not operate correctly. The frequencies chosen are in fact not suitable for transmission of digital data at a high transmission rate, necessary for voice transmission. Moreover, the transponder represented in this document, of conventional analog type, is not suitable for transmission of digital data and is easily subject to disturbance.

### OBJECT OF THE INVENTION

The object of the invention is to achieve a hands-free system not presenting the drawbacks of known systems, in particular as far as the health hazard for the user is concerned.

This object is achieved by a system according to the appended claims, in particular by the fact that the transmission-receipt circuits of the ear-piece and intermediate module are digital transmission-receipt circuits using phase modulation, the ear-piece and intermediate module communicating the digital data to one another in half-duplex transmission at a frequency of less than 1 GHz under the control of respective microprocessor-based control circuits connected to the digital transmission-receipt circuits, the control circuit of the ear-piece supplying synchronisation signals to the control circuit of the intermediate module.

The use of a relatively low transmission frequency, in the radio frequencies range, lower than microwave frequencies, enables health problems connected with use of these frequencies to be overcome.

Another object of the invention is to make use of the system as easy as possible.

According to another feature of the invention, this object is achieved by the fact that, as the ear-piece comprises means for providing an electrical power supply to the ear-piece and a control button, the latter controls both power supply of the ear-piece and connection and disconnection of the telephone via the intermediate module whose control circuit is connected via a control output of the intermediate module to a control input of the telephone.

According to a preferred embodiment, the intermediate module is a standard module connected to the telephone by a connector comprising a microprocessor containing the specific communication protocol of the telephone to which it is connected.

According to another feature of the invention, the microphone of the ear-piece is telescopic and is actuated automatically by the control button of the ear-piece.

### BRIEF DESCRIPTION OF THE DRAWINGS

Other advantages and features will become more clearly apparent from the following description of embodiments of the invention given as non-restrictive examples only and represented in the accompanying drawings, in which:

FIG. 1 is a schematic view of a particular embodiment of a system according to the invention,

FIG. 2 represents the ear-piece of the system according to FIG. 1, with the telescopic microphone in the retracted position,

FIGS. 3 and 4 respectively represent, in block diagram form, an intermediate module and an ear-piece of a system according to FIG. 1,

FIGS. 5a to 5f illustrate different electrical signals generated in a system according to the invention,

FIG. 6 schematically illustrates a customised connector that can be fitted between the intermediate module and the mobile telephone.

### DESCRIPTION OF PREFERRED EMBODIMENTS

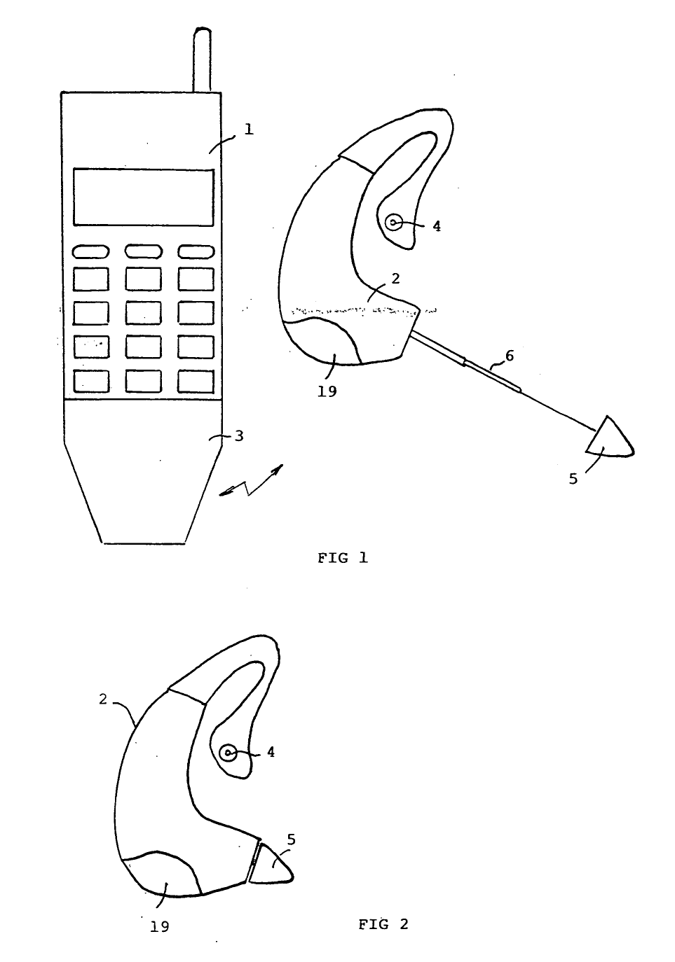

The system represented in FIG. 1 is designed to enable hands-free use of a mobile telephone 1 of conventional type. The system is formed by an ear-piece 2 and an intermediate module 3 designed to communicate with one another via a wireless radio link. The intermediate module is connected to the mobile telephone 1 by any suitable means. It is preferably clipped onto the mobile telephone by means of a connector so as to form a unit with the telephone.

The ear-piece 2 comprises a receiver 4 and a microphone 5. The microphone 5 is connected to the body of the ear-piece 2 by a stalk 6 which acts as antenna for the ear-piece. The support antenna 6 of the microphone 5 may be telescopic, as represented in FIGS. 1 and 2 respectively in the use position and in the retracted position.

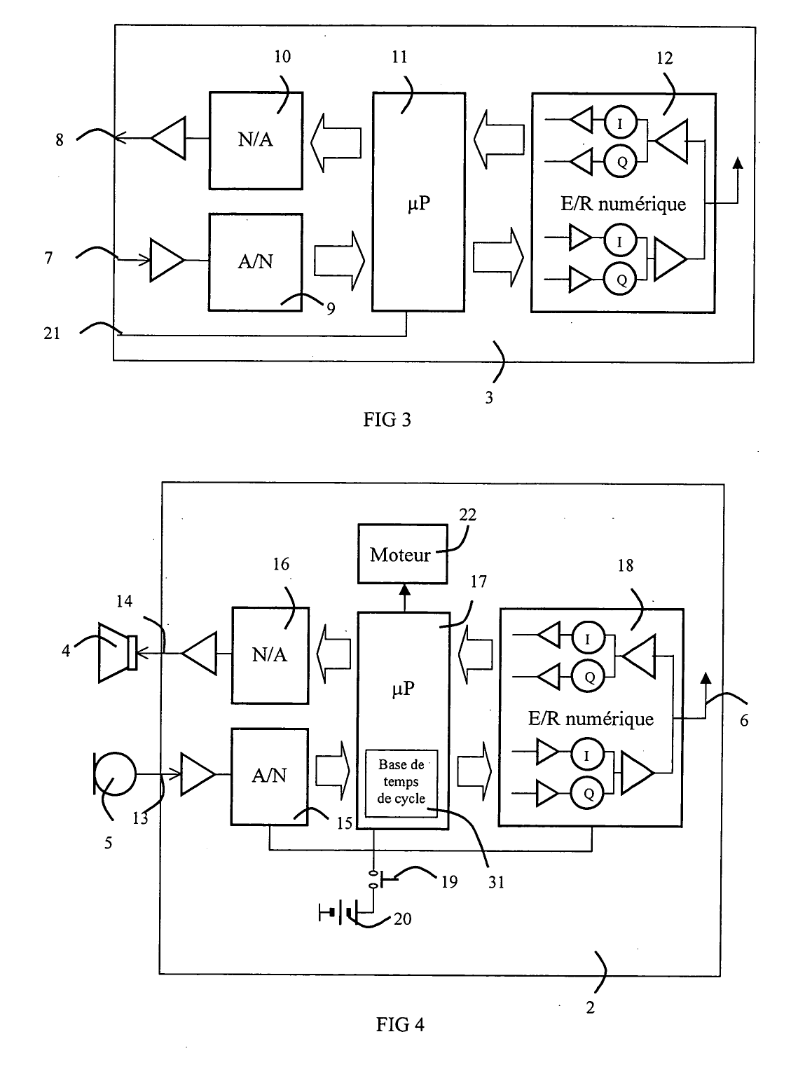

The intermediate module 3, represented in block diagram form in FIG. 3, comprises an audio input 7 and an audio output 8 respectively connected to a complementary audio input and output of the telephone 1. The audio input 7 is connected to an analog-to-digital (A/D) conversion circuit 9 and the audio output 8 is connected to an digital-to-analog (D/A) conversion circuit 10. The conversion circuits 9 and 10 are both connected to a microprocessor-based control circuit 11, itself connected to a digital transmission-receipt (T/R) circuit 12. The digital transmission-receipt circuit 12 comprises in known manner digital phase modulation and demodulation circuits using phase and phase quadrature signals (I and Q).

In like manner, the ear-piece 2, represented in block diagram form in FIG. 4, comprises an audio input 13 and an audio output 14 respectively connected to the microphone 5 and to the receiver 4 of the ear-piece. The audio input 13 is connected to an analog-to-digital (A/D) conversion circuit 15 and the audio output 14 to a digital-to-analog (D/A) conversion circuit 16. The conversion circuits 15 and 16 are both connected to a microprocessor-based control circuit 17 comprising a cycle time base 31. The control circuit 17 is connected to a digital transmission-receipt (digital T/R) circuit 18, of the same type as the circuit 12, connected to the stalk 6 acting as antenna for the ear-piece.

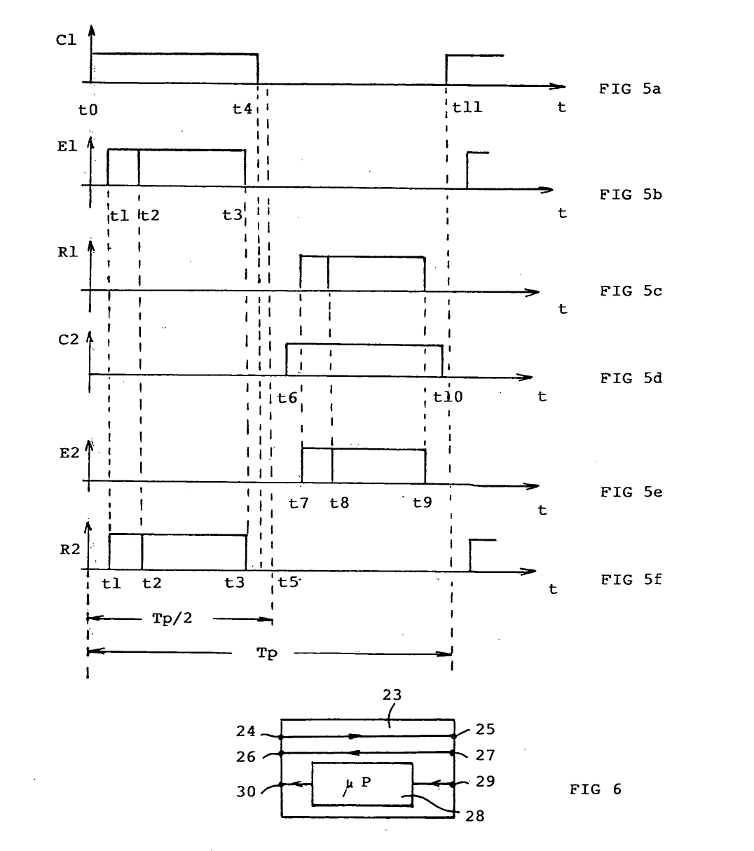

Operation of the system described above will be described with reference to the signals of FIGS. 5a to 5f.

The ear-piece 2 and intermediate module 3 communicate data converted into digital form at a preset transmission frequency situated in a radio frequency range. The transmission frequency is lower than 1 GHz, preferably about 434 MHz or about 868 MHz, these frequencies being able to be used, in particular in Europe, without any special authorisation being required. As these frequencies do not enable analog transmission of audio signals, the latter are converted to digital form both in the ear-piece and in the intermediate module.

The frequency bands chosen are narrow and do not enable full duplex transmission. Transmission therefore takes place, in known manner, in half duplex form under the control of the control circuit 17 of the ear-piece.

The purely digital transmission-receipt circuits 12 and 18 use phase modulation of the signals to be transmitted enabling protection in particular against interference to be improved. As all the users use a single transmission frequency, there are in fact risks of proximity interference between two neighbouring channels. The amplitude modulation used by digital transceivers provides little protection in this respect. The use of digital transmission-receipt circuits using phase modulation both in the ear-piece 2 and in the intermediate module 3 on the other hand enables the interference distance to be significantly increased. For example, the interference distance can be multiplied by a factor 4, increasing for example from 2 m to 8 m.

During each transmission period Tp (FIG. 5f), which may be about 20 ms, the ear-piece control circuit 17 produces binary control signals C₁ illustrated in FIG. 5a. The signals C₁ take a first preset value, 1 in the particular embodiment represented, to enable transmission between times t₀ and t₄, the time interval separating the times t₀ and t₄ being equal to or less than a transmission half-period Tp/2. The signals C, take a second preset value, 0 in the particular embodiment represented, between the time t₄ and a time t₁₁ marking the beginning of a new transmission period.

In like manner, the intermediate module control circuit 11 produces control signals C₂ (FIG. 5d) which only go to 1 to enable transmission during a time period t₆-t₁₀ within the second transmission half-period during which the ear-piece is in receipt phase (C₁=0). Synchronisation between the control signals C₁ and C₂ is performed under the control of the ear-piece which supplies appropriate synchronisation signals to the intermediate module from clock signals generated by the cycle time base 31.

In the transmission phase of the ear-piece, within the time interval t₀-t₄, the control circuit 17 of the ear-piece commands transmission of digital data (E₁, FIG. 5b) by the digital transmission-receipt circuit 18 of the ear-piece. Transmission begins at a time t₁, slightly staggered with respect to the time t₀, by transmission of address bits up to a time t₂ and of data bits up to a time t₃. These data are received (R₂, FIG. 5f) by the intermediate module which is then in receipt phase (C₂=0).

In like manner, in the transmission phase of the intermediate module, within the time interval t₆-t₁₀, the control circuit 11 commands transmission of digital data (E₂, FIG. 5e) by the digital transmission-receipt circuit 12 of the intermediate module. Transmission begins at a time t₇, slightly staggered with respect to the time t₆, by transmission of address bits up to a time t₈ and of data bits up to a time t₉. These data are received (R₁, FIG. 5c) by the ear-piece which is then in receipt phase (C₁=0).

The ear-piece 2 originates all the communications, whether it be calls or receipt of calls. It acts as a master component whereas the intermediate module 3 acts as a slave component. The intermediate module merely answers by its own frame any digital audio frame originating from the ear-piece.

Assigning a preset digital address to each system enables risks of interference between two systems to be prevented. Data transmission is in fact systematically preceded by transmission of address bits which enable the control circuit in receipt phase to check whether or not the data are intended for it and to only take them into consideration if the address received corresponds to its own address.

The ear-piece 2 comprises in addition a control button 19 (FIGS. 1, 2 and 4), preferably situated on a part of the ear-piece located behind the user's ear lobe when the latter is wearing the ear-piece. This button must be easy to access and relatively large.

The control button 19 presents a first function of power-on of the ear-piece. As represented in FIG. 4, the control button 19 is placed between electrical power supply means of the ear-piece, preferably formed by a battery 20 of small dimensions, and the various electronic circuits (15, 17, 18) of the ear-piece which have to be supplied with power.

The control button 19 preferably presents a second function of remote control of the telephone. This function enables connection and disconnection of the telephone to be performed automatically by simply pressing the control button 19, respectively when powering the ear-piece on and off. To perform this function, the first data transmitted by the ear-piece in a first transmission phase following power-on are not constituted by audio data but by a telephone connection order. This order is then received by the control circuit of the intermediate module 3 associated to the ear-piece, which transmits it to the telephone via a control output 21 connected to a complementary control input of the telephone. In like manner, a telephone hang-up order transmitted by the control circuit 17 of the ear-piece when the control button 19 is pressed again to end the phone call and switch the ear-piece off is transmitted to the control input of the telephone via the control circuit 11 of the intermediate module.

In a preferred embodiment, the control button at the same time presents a third function of actuating the microphone 5 of the ear-piece when the microphone is telescopic (FIGS. 1 and 2). Power-on of the ear-piece control circuit 17 automatically performs momentary supply of a small motor 22 actuating the support stalk 6 of the microphone 5 (FIG. 4).

Thus, when the control button 19 of the ear-piece has the three-fold function described above, simply pressing this button when the phone bell rings switches the ear-piece on, places the ear-piece microphone 5 in the right position and connects the phone receiver. In like manner, at the end of the phone conversation, pressing the control button 19 again enables the user at the same time to hang the phone up, to move the ear-piece microphone to the retracted position where it is less in the way, and to switch off the power supply to the ear-piece. Switching the ear-piece power supply off outside phone conversation periods enables the battery consumption to be reduced and consequently enables its lifetime to be increased and/or its dimensions to be reduced.

Commanding connection and disconnection of the telephone implies that the orders are transmitted to the telephone in a suitable form, understood by the latter. The parameters of the intermediate module control circuit 11 can be set so as to enable remote control of a predetermined type of telephone. A memory can contain all the communication protocols used by different types of telephones, customisation of the system to match it to the phone used being performed at a late a stage as possible.

In a preferred embodiment, the intermediate module 3 is a standard module transmitting simple binary signals on its control output 21, for example a signal 1 to command a change of state of the telephone, i.e. connection or disconnection depending on the case. Adaptation of the telephone control signals is then performed inside a connector 23 located between the intermediate module and the telephone. Customisation of the system is then performed by choosing a suitable connector. The user who changes his type of telephone can then continue using the same system, only having to change the connector.

FIG. 6 schematically illustrates a customised connector 23 that can be fitted between a standard intermediate module and the telephone. The connector 23 comprises a first audio input 24 designed to be connected to the audio output of the telephone. It also comprises a first audio output 25 which is connected directly to the first audio input 24 and which is designed to be connected to the audio input 7 of the intermediate module 3. It also comprises a second audio output 26 designed to be connected to the audio input of the telephone, and a second audio input 27 which is connected directly to the second audio input 26 and which is designed to be connected to the audio output 8 of the intermediate module 3. The connector 6 in addition comprises a microprocessor 28, connected between a control input 29 designed to be connected to the control output 21 of the intermediate module, and a control output 30 designed to be connected to the control input of the telephone. The microprocessor is customised to perform matching of the phone line connection and disconnection signals, which are supplied to it by the intermediate module, with the type of telephone used.

The ear-piece and intermediate module thereby constitute a universal wireless system suitable for all types of telephone if the telephone remote control function is not used. Should this function be required, the system is easily adaptable to any type of telephone due to the customised connector.

The distance separating the ear-piece 2 from the intermediate module 3 fixed onto the mobile telephone 1 is always limited, generally to a few metres at the most. The power emitted to perform transmission can therefore be limited. In a preferred embodiment, the power emitted is less than 1 mW. The data are transmitted with a transmission rate of 16 kbits/s between the control circuits 11, 17 and the conversion circuits 9, 10; 15, 16 and with a transmission rate of 64 kbits/s between the control circuits 11, 17 and the transmission-receipt circuits 12, 18. The combination of the use of radio frequencies and a low transmission power makes the system perfectly inoffensive for the user's health.

1. A wireless system comprising an ear-piece (2) and an intermediate module (3) connected to a mobile telephone (1), the ear-piece and intermediate module both comprising a transmission-receipt circuit (18, 12) to communicate digital data to one another at a preset transmission frequency, a system characterized in that the transmission-receipt circuits (18, 12) of the ear-piece and intermediate module are digital transmission-receipt circuits using phase modulation, the ear-piece and intermediate module communicating digital data to one another in half-duplex transmission at a frequency of less than 1 GHz under the control of respective microprocessor-based control circuits (17, 11) connected to the digital transmission-receipt circuits, the control circuit (17) of the ear-piece (2) supplying synchronisation signals to the control circuit (11) of the intermediate module (3).

2. The system according to claim 1, characterized in that the ear-piece (2) and intermediate module (3) both comprise:
an audio output (14, 8) connected to a receiver (4) in the ear-phone and to an audio input of the telephone in the intermediate module,
an audio input (13, 7) connected to a microphone (5) in the ear-piece and to an audio output of the telephone in the intermediate module,
an analog-to-digital conversion circuit (15, 9) connected between the audio input (13, 7) and the associated control circuit (17, 11), and
a digital-to-analog conversion circuit (16, 10) connected between the control circuit (17, 11) and the associated audio output (14, 8).

3. The system according to one of the claims 1 and 2, characterized in that the transmission frequency is 434 MHz.

4. The system according to one of the claims 1 and 2, characterized in that the transmission frequency is 868 MHz.

5. The system according to any one of the claims 1 to 4, characterized in that a pre-determined digital address is assigned to each system, the control circuits (17, 11) of the ear-piece (2) and of the intermediate module (3) inserting this address in the data to be transmitted.

6. The system according to any one of the claims 1 to 5, characterized in that, as the ear-piece (2) comprises means (20) for providing an electrical power supply to the ear-piece and a control button (19), the latter controls both power supply of the ear-piece and connection and disconnection of the telephone via the intermediate module (3), whose control circuit (11) is connected via a control output (21) of the intermediate module to a control input of the telephone.

7. The system according to claim 6, characterized in that the intermediate module (3) is a standard module connected to the telephone (1) by a connector (23) comprising a micro-processor (28) containing the specific communication protocol of the telephone (1) to which it is connected.

8. The system according to one of the claims 6 and 7, characterized in that the micro-phone (5) of the ear-piece (2) is telescopic and is actuated automatically by the control button (19) of the ear-piece.
